(19) United States
(12) Patent Application Publication
(10) Pub. No.: US 2023/0142774 A1
(43) Pub. Date: May 11, 2023

(54) DYNAMIC ACTION-DRIVEN VISUAL TASK FLOW

(71) Applicant: AT&T Intellectual Property I, L.P., Atlanta, GA (US)

(72) Inventors: Seyed A. Hashemi, Johns Creek, GA (US); Lavanya Subramanian, Dunwoody, GA (US)

(21) Appl. No.: 17/519,970

(22) Filed: Nov. 5, 2021

(51) Int. Cl. G06F 9/48; G06F 9/30; G06F 9/445; G06F 9/38

(52) U.S. Cl. CPC G06F 9/4881; G06F 9/3005; G06F 9/44505; G06F 9/3838

(57) ABSTRACT

Architectures and techniques are presented that provide a dynamic, action-driven visual task flow customization to a software-as-a-service (SaaS) platform. A task element, expressing a task workflow can be modeled as a record of an order data model of the development environment. The task workflow can be executing according to a flow state management procedure, e.g., to manage lifecycle. In response to the flow state management procedure, the record can be updated according to a current state of the task element. These task elements can be correlated to an action or other operation of a flow designer module of the SaaS platform, which can leverage native automation.

### TECHNICAL FIELD

The present application relates generally to a customization to a software-as-a-service (SaaS) development environment and more particularly to a customization that can provide dynamic action-driven visual task flow elements within the development environment.

### BACKGROUND

Conventional software-as-a-service (SaaS) platforms frequently provide a development environment and other tools that can allow customers to program for their own needs. One example is the Servicenow® SaaS platform, which provides a flow designer tool with which a customer can program certain configurations or customizations.

### BRIEF DESCRIPTION OF THE DRAWINGS

Numerous aspects, embodiments, objects and advantages of the present application will be apparent upon consideration of the following detailed description, taken in conjunction with the accompanying drawings, in which like reference characters refer to like parts throughout, and in which:

FIG. 1 a schematic block diagram of an example SaaS platform is presented in accordance with certain embodiments of this disclosure;

FIG. 2 shows an example schematic block diagram illustrating an example device that can implement dynamic, action-driven visual task flow customizations to an SaaS platform in accordance with certain embodiments of this disclosure;

FIG. 3A depicts a schematic block diagram illustrating two example customizations 206 such as a task data model customization and a task flow and state customization in accordance with certain embodiments of this disclosure;

FIG. 3B depicts a schematic block diagram illustrating an example task flow state management procedure in accordance with certain embodiments of this disclosure;

FIG. 3C depicts a schematic block diagram illustrating a task flow runtime example for the state management procedure in connection with tasks and related actions in accordance with certain embodiments of this disclosure;

FIG. 4 depicts a schematic block diagram is depicted illustrating three additional example customizations, such as a task flow control customization, a task flow synchronization customization, and a task visualization customization in accordance with certain embodiments of this disclosure;

FIG. 5 shows a schematic diagram 500 illustrating design of a link aggregation (LAG) circuit between a converged access switch and a hub router to flow mobile network traffic from RAN-Transport to Mobile Core network in accordance with certain embodiments of this disclosure;

FIG. 6 illustrates an example method that can provide a dynamic, action-driven visual task flow customization in and SaaS platform in accordance with certain embodiments of this disclosure;

FIG. 7 illustrates an example method that can provide for additional elements or aspects in connection with the dynamic, action-driven visual task flow customization in accordance with certain embodiments of this disclosure;

FIG. 8 illustrates a first example of a wireless communications environment with associated components that can be operable to execute certain embodiments of this disclosure;

FIG. 9 illustrates a second example of a wireless communications environment with associated components that can be operable to execute certain embodiments of this disclosure; and

FIG. 10 illustrates an example block diagram of a computer operable to execute certain embodiments of this disclosure.

### DETAILED DESCRIPTION

### Overview

In the networking space, network inventory and network service design relies on orchestration capabilities in order to manage a series of automated and/or manual steps to support the network operations work centers (NOWC). These steps can be modeled in the workflow to track various dependencies in the network planning or design, including network build and network rollout applications. In order to meet various goals such as network planning and design, asset inventory design, network service design, automated network build and orchestration of network services for implementation or rollout, and so forth, network providers can utilize software-as-a-service (SaaS) platforms, such as a Servicenow® Saas platform.

As detailed in the Background section, SaaS platforms frequently provide a development environment or other tools that can allow customers to program for their own needs. However, these platforms are sophisticated and typically cannot be utilized effectively by those without significant high-level programming skills.

NOWC are typically staffed with employees that would be slated to utilize the SaaS platform to accomplish the above-mentioned goals. However, NOWC staff typically do not have significant high-level programming skills and therefore are unlikely to successfully use the SaaS platform in current forms.

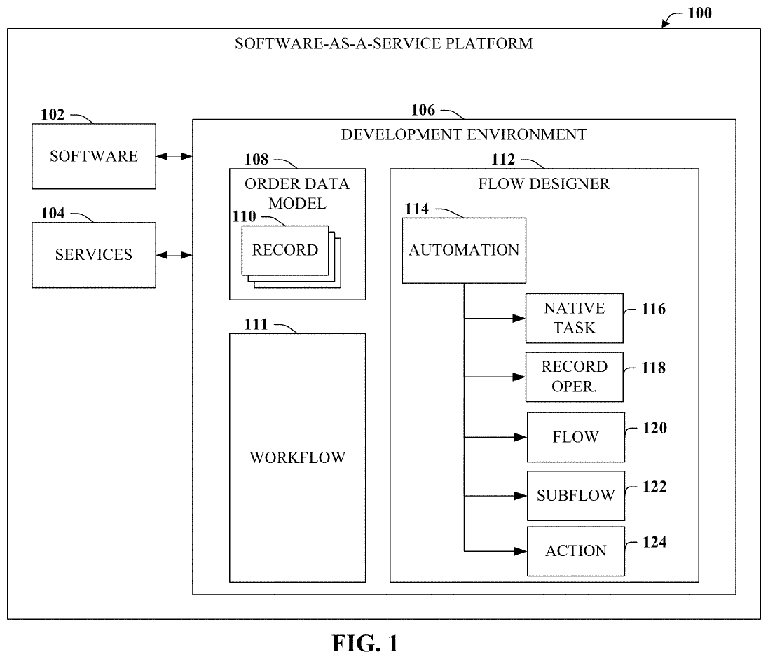

The disclosed subject matter is directed to certain customizations to a SaaS platform, e.g., customizations to the Servicenow® Saas platform. These customizations can leverage native platform capabilities and build a simplified user experience for the end-user, such as a NOWC staff end-user. An overlying objective of the disclosed subject matter is to allow the SaaS platform automation and activities to be view and managed in a visual way. Certain details regarding an example SaaS platform are provided in connection with FIG. 1.

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

With reference now to FIG. 1, a schematic block diagram of an example SaaS platform 100 is presented in accordance with certain embodiments of this disclosure. SaaS platform 100 can comprise various software 102 and provide various services 104. Further, SaaS platform 100 can provide development environment 106.

Certain SaaS platforms 100, such as the Servicenow® Saas platform provides an order data model 108. Order data model 108 can provide a framework that enables telecom service providers to manage, orchestrate, and fulfill customer orders for different types of products and services. Typically, order data model 108 allows data (e.g., customer orders and others) to be stored in records 110. Order data model 108 can enable a user to move a customer order or other data through various stages of an order life cycle. However, order data model 108 does not natively have a workflow capability. Instead workflow capability is provided via a configuration and customization environment.

For example, development environment 106 can have two workflow solutions, illustrated here as workflow tool 111 and flow designer 112. Servicenow® recommends using flow designer 112 for new solution implementations as it is promoted to be more suitable for configuration and customization. However, neither of these tools provide a simple visual display or intuitive user interface (UI) behavior for an end-user who has no platform development or customization skills. Moreover, these tools do not provide the level of sophistication used to perform state management for elongated automation processes that involve, e.g., the planning, designing, and building of network solutions and services.

Flow designer 112 is part of a framework configured to enable automation 114 of approvals, native tasks 116, notifications, and record operations 118, flows 120, subflows 122, and actions 124 in the development environment 106. Flow 120 is an automated process consisting of a trigger and a sequence of actions. Flows 120 automate business logic for a particular application or process. Subflow 122 is an automated process consisting of a sequence of reusable actions, data inputs, and outputs. In contrast to flows 120, subflows 122 do not have a trigger but instead run within a flow 120, another subflow 122, or a script. Action 124 is a reusable operation that enables process analysts to automate SaaS platform 100 features. In some cases, actions 124 can provide automation 114. Automation 114 is a useful tool, but as previously noted, the current UI is not suitable for many end-users and certain elements are lacking for generating useful workflows.

For network service provider operations end-users (e.g., NOWC staff), who do not perform developer activities in a development platform, the UI offered by flow designer 112 is not suitable. Rather such may cause confusion and undesired outcomes from an end-user perspective. While some permission control can be applied to limit unwanted edit capabilities, the UI does not lend itself to simplicity for an end-user to view information and perform simple actions such as to move the workflow and work-in-progress forward. A simplification to SaaS platforms for the end-users, to allow dynamic, action-driven task flows that can allow end-users to manage day-to-day business activities and increase the end-user productivity for often-repeated tasks would be a welcome advance to the existing state of art.

### Example Systems

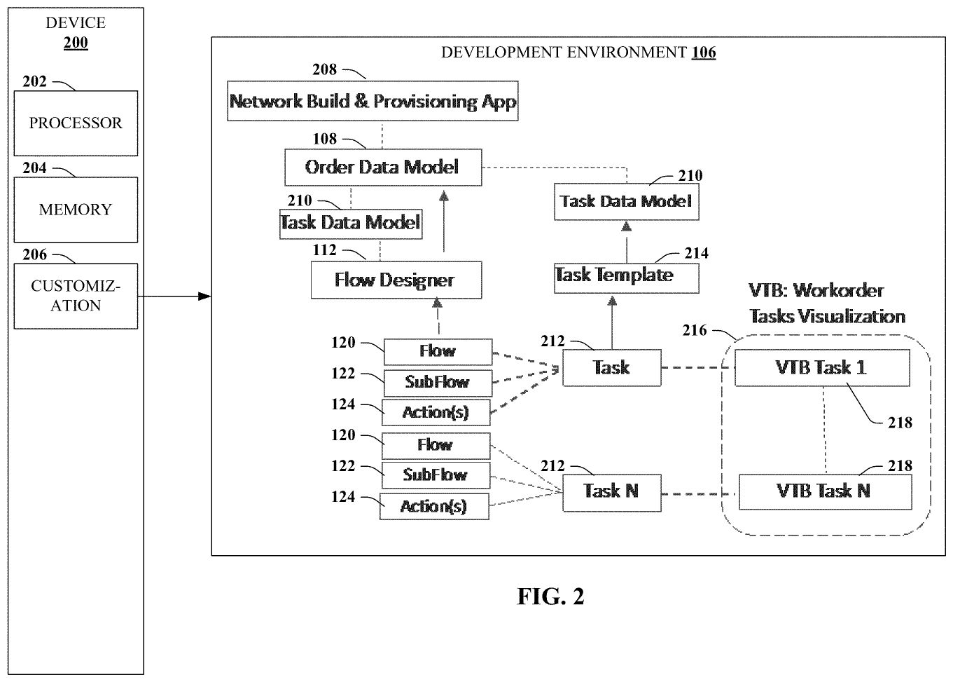

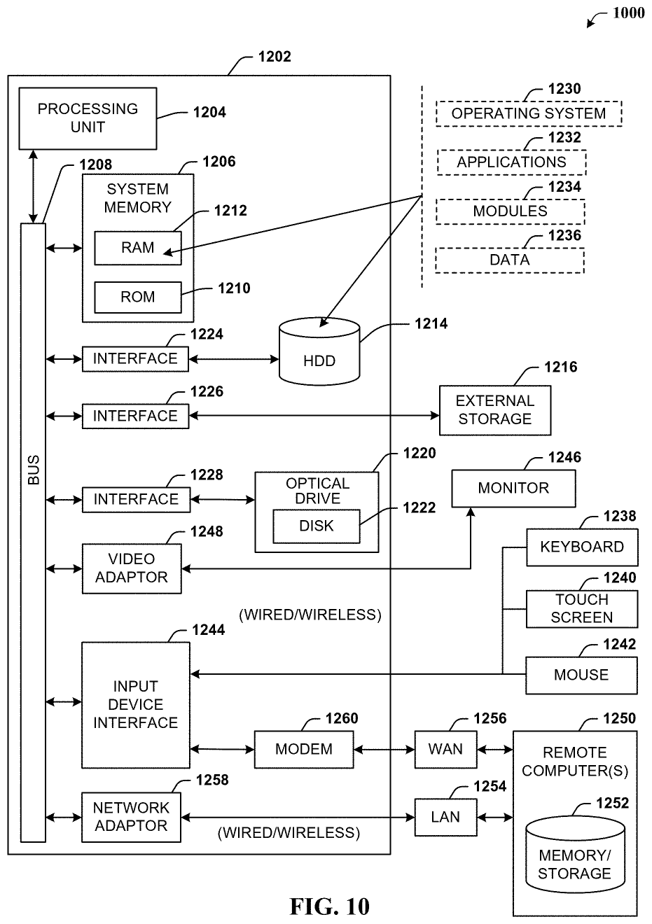

Referring now to FIG. 2, an example schematic block diagram is depicted illustrating an example device 200 that can implement dynamic, action-driven visual task flow customizations to SaaS platform 100 in accordance with certain embodiments of this disclosure. For example, device 200 can be a network device of a network provider that provides customization 206. Device 200 can comprise a processor 202 that can be specifically configured to provide customization 206. Device 200 can also comprise memory 204 that stores executable instructions that, when executed by processor 202, can facilitate performance of operations. Processor 202 can be a hardware processor having structural elements known to exist in connection with processing units or circuits, with various operations of processor 202 being represented by functional elements shown in the drawings herein that can require special-purpose instructions, for example stored in memory 204 and/or record procedure 206 component or circuit. Along with these special-purpose instructions, processor 202 and/or device 200 can be a special-purpose device. Further examples of the memory 204 and processor 202 can be found with reference to FIG. 10. It is to be appreciated that device 200 or computer 2002 can represent a server device of a communications network or a user equipment device and can be used in connection with implementing one or more of the systems, devices, or components shown and described in connection with FIG. 2 and other figures disclosed herein.

As noted, customizations 206 detailed herein can leverage the native SaaS platform 100 capabilities to create a simplified user experience for an end-user, such as a NOWC end-user. By using customization 206, native SaaS platform 100 automation (e.g., automation 114) and other features can be viewed and managed in a visual way. Initially, customization 206 can include creation of network build and provisioning application 208 or another suitable application for which to generate customization 206. In this example, customization 206 can dynamically create a task-based workflow model, illustrated here as task data model 210. Tasks 212 of task data model 210 can be correlated to the automated flows 120, subflows 122, and actions 124 that are part of the Flow Designer module of the SaaS platform 100. These tasks 212 can also be added to a visual task board (VTB) 216 automatically, illustrated by reference numeral 218, thus creating a customer-centric view where the workflow automation activities and their transition states (detailed infra) can be presented. Such can accommodate the needs of the operations end-user without relying on the end-user utilizing the native flow designer 112 tool that is complex and non-intuitive to some users.

By way of example, customization 206 can implement a workflow system solution for, e.g., 5G radio access network (RAN), transport, core networks, and other network domains such that these operations can be transported to the SaaS platform 100. The simplification of user experiences with visual task-based workflow representations can increase end-user efficiency and productivity. Further, such customizations 206 can be imported as a core platform capability of the underlying SaaS platform 100 for other service providers and wider industry usage. Customizations 206 can allow SaaS platform 100 new capabilities to simplify the end-user experience, increase platform usage in network design and rollout and increase overall productivity.

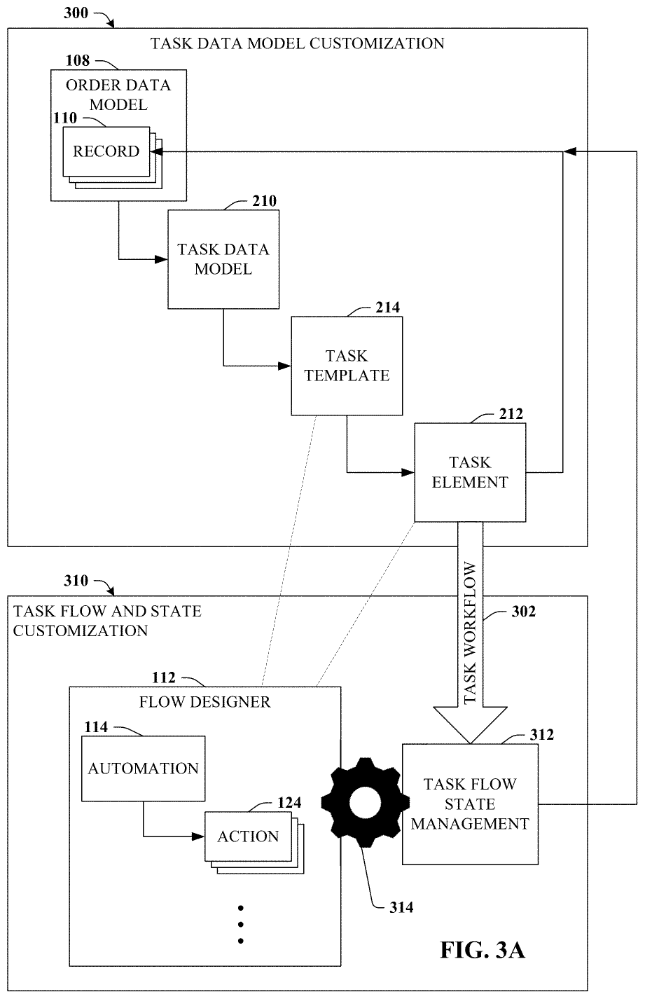

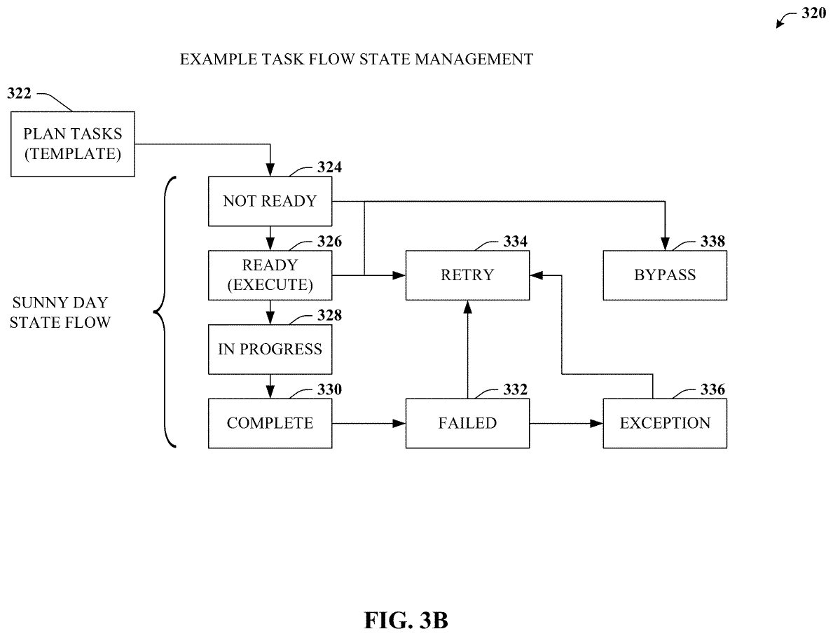

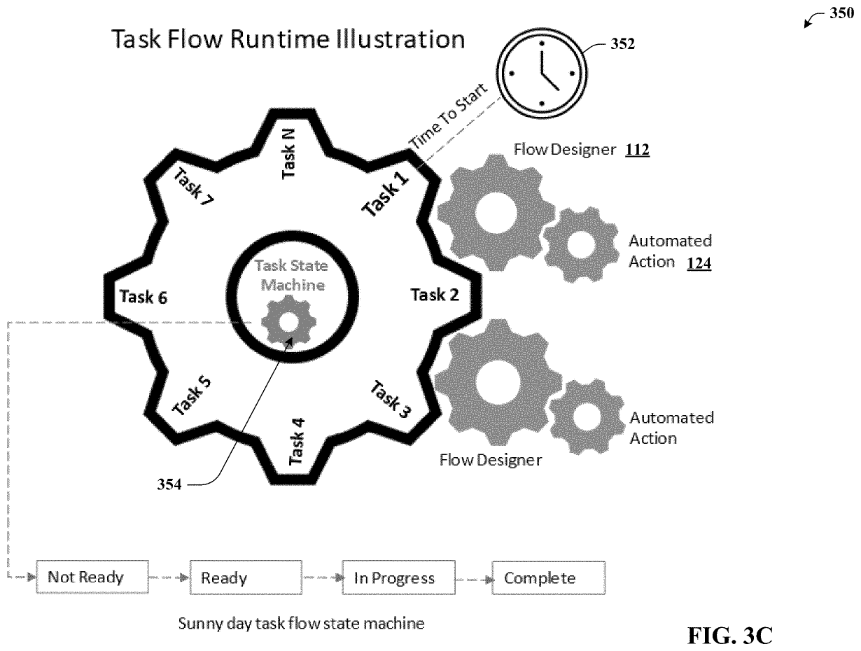

While still referring to FIG. 2, but turning now as well to FIG. 3A, a schematic block diagram illustrating two example customizations 206 is depicted. Namely, FIG. 3A illustrates a task data model customization 300 and a task flow and state customization 310 in accordance with certain embodiments of this disclosure. In order to create a visual representation of workflow steps in SaaS platform 100, customization 206 can include task data model 210 that can include data elements used by flow designer 112 to perform automation 114. Task data model 210 can be part of order data model 108 that empowers flow designer 112 workflow 120, subflow 122, and actions 124. Thus, order data model 108 can be a superset and task data model 210 as the subset. Tasks 212 can be modeled as records 110 in a task table.

Hence, task 212 can express a task workflow 302. However, because records 110 are typically simple data, a question arises of how to manage lifecycle for a task 212. In that regard, task workflow 302 can be executed by task flow state management procedure 312. Thus, when a task workflow 302 changes state (as further detailed in connection with FIG. 3B), an associated record 110 of order data model 108 can be updated to reflect that state change. Hence, task 212 and/or task templates 214 can leverage automation 114 of flow designer 112.

The automation 114 of the task flow 302 can consist of multiple automated actions 124 that can be handled by correlating tasks 212 along with the state management of the tasks 212. As the flow designer 112 automated flows 120, subflow 122, or actions 124 progress, the record 110 associated with task 212 can be updated to reflect the current state of task 212 and the automated action performed, which is explained in more detail with reference to FIG. 3B. Likewise, task flow state management procedure 312 can manage states of tasks 212 and related actions 124 in flow designer 112, as illustrated by reference numeral 314, which is further detailed in connection with FIG. 3C.

While still referring to FIGS. 2 and 3A, but turning now as well to FIG. 3B, a schematic block diagram is depicted, illustrating an example task flow state management procedure in accordance with certain embodiments of this disclosure. Task flows 302 associated with tasks 212 or task templates 214 can be executed by task flow state management procedure 312, which is illustrated at reference numeral 322. Initially, task flow 302 enters the not ready state 324, and the sunny day state flow proceeds to ready state 326, to in progress state 328, and then to complete state 330.

Once the full automation is executed successfully, task flow 302 (and/or by proxy, task 212) can be marked ‘Complete’. In the case of failure (e.g., failure state 332) in the automation, an exception task (e.g., exception state 336) can be created. Furthermore, such an exception task can be correlated to an incident or problem record. Some common examples of such issues can include: a software issue assigned to an IT staff group or a network design data issue assigned to an operations staff exception task group. The Task should be retryable (e.g., retry 334), to allow the user to re-execute the same automation with no constraint or negative impact. The automated action(s) can have the intelligence to care for any contention and perform a refresh of record or table updates. The user also can by-pass an automation (e.g., bypass 338) by moving the task into a final state, which marks the completion of the task.

With regard to task 212 creation, execution, and state management, order model 108 can include records 110 of tasks 212 and/or task templates 214. Model task records for each workflow step can set the task ownership. For instance, ownership can be defined as ‘system’ or ‘user group’ that represents an operation work center such as NOWC.

Likewise, a relationship between action(s) 124 SaaS platform 100 and task 212 record can be constructed. From task template 214, plan tasks 212 with milestones that enable triggers to execute tasks 212 can be constructed. Tasks 212 and associated actions can be executed to complete an automation 114, which can be exemplified by the in progress state 328. Retry 334 can be performed on tasks 212 that completed 330 or failed (e.g., failed state 332). Further, bypass 338 can be allowed for an active or failed task to move the flow forward. As noted, an exception 336 task can be created which may guide the user to retry a task or to a manual resolution or allow bypass 338 to move the flow forward. Likewise, the task flow state management procedure 312 can manage states of tasks and related actions in flow designer 112, as illustrated in FIG. 3C.

Referring now to FIG. 3C, a schematic diagram 350 is depicted illustrating an example task flow runtime of the state management procedure in connection with tasks 212 and related actions 124 in accordance with certain embodiments of this disclosure. For example, a given task flow (e.g., task flow 302) can have a start time 352. Such can be independently determined for each of the many tasks 1 through N.

A given task can be executed by flow designer 112, e.g., via automating actions 124. The task flow can represent a macro workflow runtime execution, which can be driven by a task state machine 354 that can be included in task flow state management procedure 312. This task state machine 354 can manage (e.g., according to the sunny day, or other, task flow states detailed in connection with FIG. 3B) the execution in response to a trigger such as milestones that are defined in task template (e.g., task template 214) and/or a task planning phase. Additionally or alternatively, a trigger can be activated in response to a completion of another automated step or action, or an inbound notification.

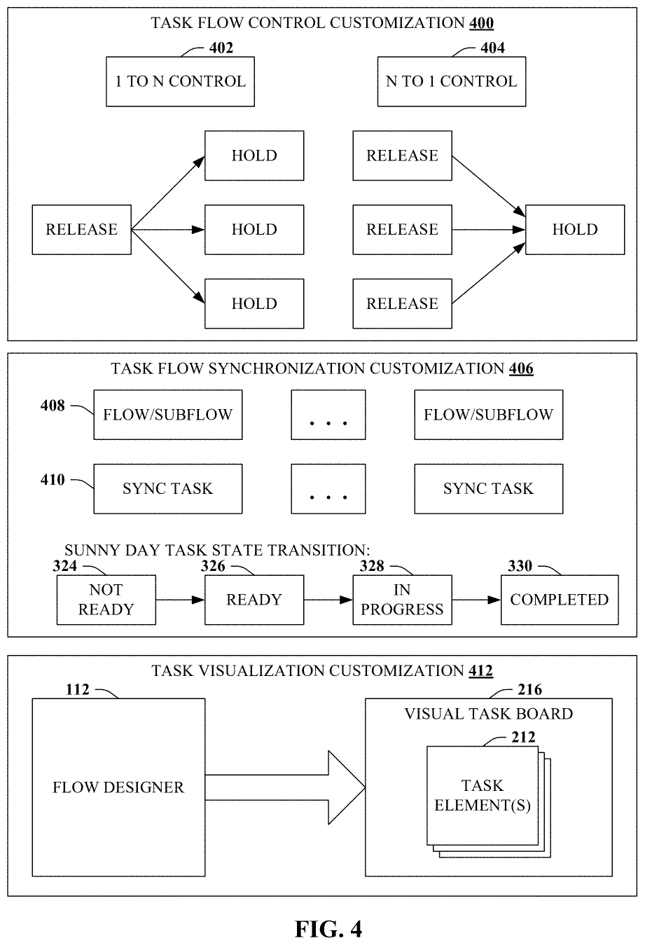

Turning now to FIG. 4, a schematic diagram is depicted illustrating three additional example customizations 206. Namely, FIG. 4 illustrates a task flow control customization 400, a task flow synchronization customization 406, and a task visualization customization 412 in accordance with certain embodiments of this disclosure. With initial reference to task flow control customization 400, flows can be held or released based on a one-to-many control 402 or a many-to-one control 404. For example, the relationship between flow designer 112 and tasks 212 can be based on the one-to-many concept. A flow designer 112 can have one or more tasks 212. The relationship between tasks 212 to actions 124 can also be one-to-many. A given task 212 can have one or many automated actions 124. Similarly, the relationship between order data model 108 to flow designer 112 can be one-to-many. That is, an order may have one or more flow designer 112 automation 114. Such can allow an end-user to manage dependencies across multiple flows with dynamic action based task flow as detailed herein. Such can also ensure data synchronization between flows 302 and tasks 212.

With regard to task flow synchronization, flows/subflows 408 can be synchronized, e.g., to manage the state of data for successful automation execution. Such can be accomplished via sync task 410 that can complete when all sync tasks in the same flow/subflow 408 are in a later state than the not ready state 324. The sunny day task state transition is similar to that provided in FIG. 3B with respect to task flow state management procedure 312.

Regarding task visualization customization 412, VTB 216 that is part of some SaaS platforms 100 and/or flow designer 112, can be automatically populated with tasks 212. Thus, NOWC staff or other end-users can be presented with dynamic, action driven visual task flows with which to perform their jobs without relying on traditional programming skills.

Simplification in automation can increase productivity of the NOWC staff end-users to perform repetitive daily tasks, e.g., to design, built, activate, monitor, troubleshoot and maintain the network and network services. With the fast-paced network technology evolution, automation and simplification is seen by some as a necessity, rather than an option. 5G network architecture which is designed as a software defined network, and cloud native solution and supports network services as a slice from Radio Access Network to the infrastructure transport network and Mobile core network. This created a level of complexity where an automated process is necessary for the Mobile Network Operator (MNO) to build and maintain the network. While the automation may be seen as a necessity, simplicity of the automation tool is also significant for the MNO to manage the operations center resources skill set and create efficiency and productivity to meet the day-to-day business challenges.

Dynamic, action-driven task-based flow can enable customization of SaaS platform 100, such as the Servicenow® SaaS platform to the level that Operations staff do not need to have a deep knowledge, like IT staff, to work with the platform. This can have a significant Total Cost of Ownership (TCO) reduction for an MNO who has tens of thousands of staffs that perform daily tasks in the application to design, build, monitor and maintain the network services.

To provide additional detail, the following use case is illustrated to give a concrete example of implementation and use of customizations 206 or other elements disclosed herein.

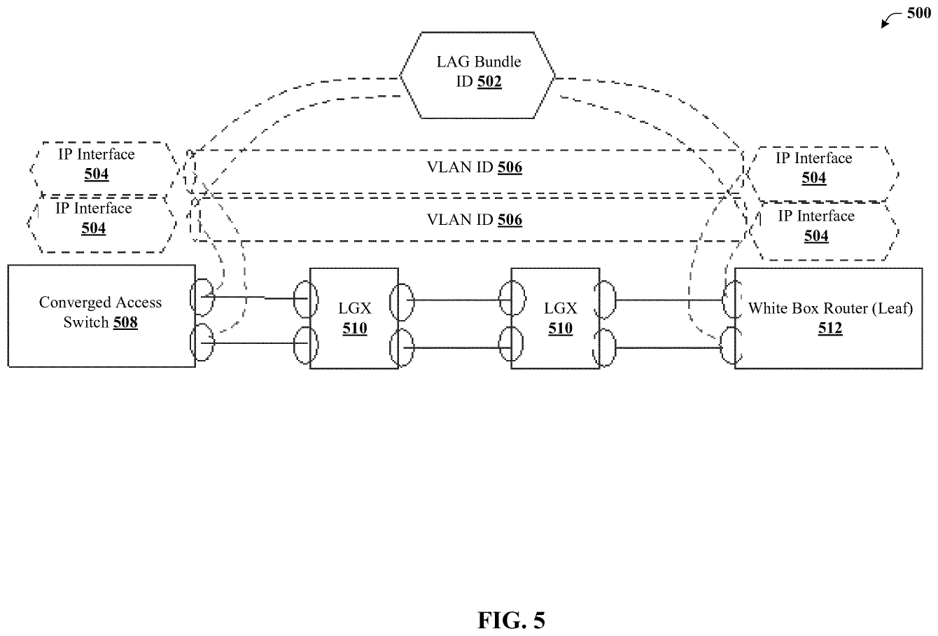

Referring now to FIG. 5, a schematic diagram 500 illustrating design of a link aggregation (LAG) circuit between a converged access switch 508 and a hub router (e.g., White box router (Leaf) 512) to flow mobile network traffic from RAN-Transport to Mobile Core network in accordance with certain embodiments of this disclosure. In this scenario, both network elements are co-located, there are 2 L1 LGX 510 to provide Fiber Cable Physical Connectivity and each physical link will have a single VLAN ID 506 with IP interfaces 504, which are related to LAG Bundle ID 502. All the traffic is aggregated using the LAG configurations. It is appreciated that while this is merely one example, the disclosed concepts can be leveraged to create any other suitable use case in a like manner.

In order to implement the example LAG in the context of SaaS platform 100, the operation can begin by creating network provisioning user groups with roles to manage the tasks, problems, incidents, actions, and flow designer 112 process automation 114 in SaaS platform 100. Such can be achieved via network build and provisioning application 208, for example. In some embodiments, a network provisioning orchestration application can be constructed as well, e.g., to manage relationships between various elements. A network build order data model can be constructed (e.g., leveraging order data model 108), which can include task data model 210 for every expected task record in the automation process specific to the proposed LAG use case.

A template for task records (e.g., task template 214) can be created for converged access switch to hub router flow designer 112 activities. Such can model automation activities (e.g., automation 114) as an “action>task” in SaaS platform 100. A task can be an auto-task, which the system can execute automatically or a manual task, which may require end-user action. A flow designer 112 flow can be created with all the desired actions to perform the LAG design processing (e.g., L1 physical link, L2 VLAN, L3 IP interface, . . . ), including data validation, physical link creation, LAG design, and integration with other external interfaces.

Task records can be created from the workflow task template 214. These task records can correlate the flow designer 112 actions 124 to the task records. Such can include a data model relationship between actions 124 and tasks 212. The implemented correlation can create a view of actions 124 automation 114 within task flow 302 and perform task state management (e.g., via task flow state management procedure 312), while allowing the visualization of automation in a simpler way.

A visual task board 216 can be dynamically (e.g., programmatically) created for the use case, which may be initiated from flow designer 112. Tasks 212 in task template 214 can be associated with and/or added to or populate visual task board 216. Such can allow an end-user to visualize the workflow actions in the task format on the visual task board 216, including, e.g., status and history of the action 124 performed for each task 212. Such can also all drilling down from task 212 to visualize detailed task information, including task processing and historical information.

Enable task flow state management 312 from the task 212 on the visual task board 216, such as retry 334, bypass 338, completion 330, for example. If a user decides to complete a task 212 (e.g., via bypass 338) the action can move the flow designer 112 automation 114 to the next step in the flow.

If the task automation failed (e.g., failed state 332), an exception record can be dynamically created. In some embodiments, such can be a problem record in the SaaS platform 100 if the failure is linked to a software issue which is typically handled by IT staff user group assignment; or an incident record if operations user group assignment is identified instead. Visual exception tasks can be dynamically created on the visual task board 216. Such can enable an end-user to stop the flow (e.g., wait) and monitor an associated resolution status.

### Example Methods

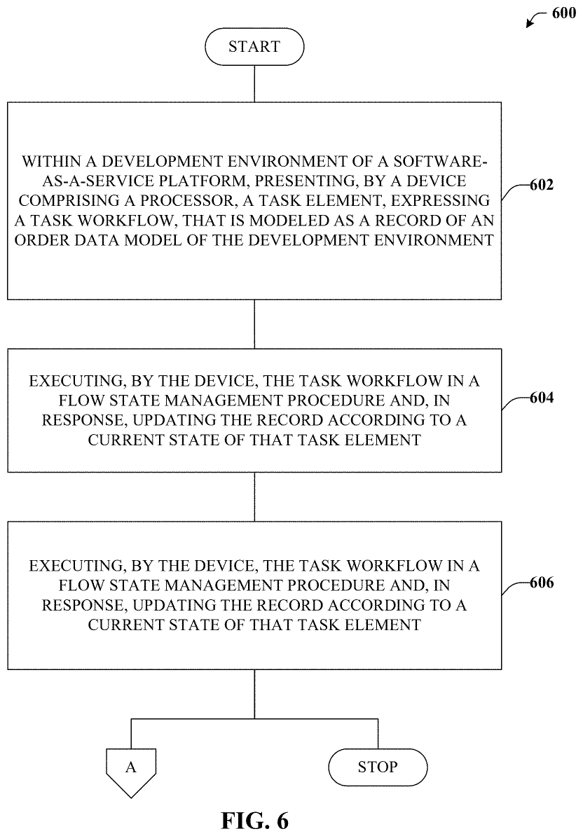

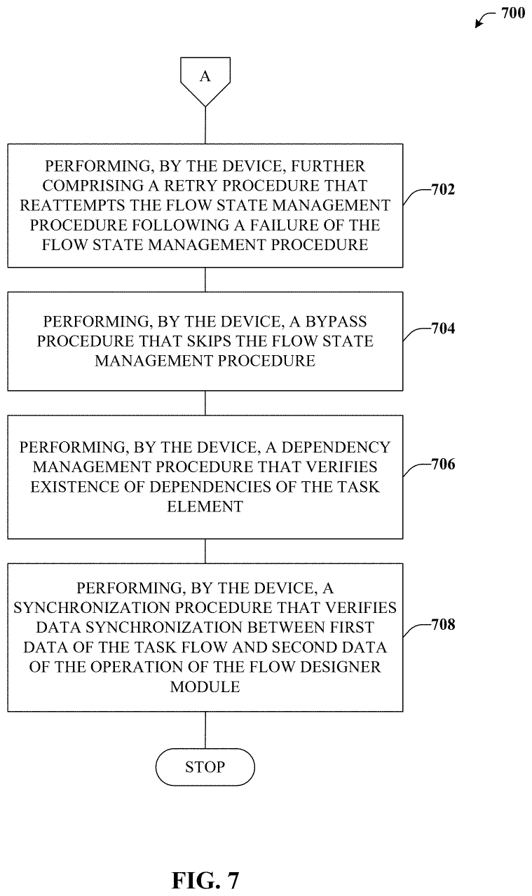

FIGS. 6 and 7 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the disclosed subject matter. Additionally, it should be further appreciated that the methodologies disclosed hereinafter and throughout this specification are capable of being stored on an article of manufacture to facilitate transporting and transferring such methodologies to computers.

Turning now to FIG. 6, exemplary method 600 is depicted. Method 600 can provide a dynamic, action-driven visual task flow customization in and SaaS platform in accordance with certain embodiments of this disclosure. For example, at reference numeral 602, a device comprising a processor can, within a development environment of a software-as-a-service platform, present a task element, expressing a task workflow, that is modeled as a record of an order data model of the development environment. In some embodiments, such can be presented to a visual task board generated by a flow designer module of SaaS platform. Hence, the customization can include both a new task model and automatically populating the visual task board with the task elements.

At reference numeral 604, the device can execute the task workflow (e.g., expressed by the task element) in a flow state management procedure. In response to the flow state management procedure, the device can update the record according to a current state of that task element. Appreciably, the record is typically a part of the order data model.

At reference numeral 606, the device can construct a relationship between the task element and an operation of a flow designer module of the development environment For example, the operation of the flow designer module can be, e.g., an action. Method 600 can stop or proceed to insert A, which is further detailed in connection with FIG. 7.

With reference now to FIG. 7, exemplary method 700 is illustrated. Method 700 can provide for additional elements or aspects in connection with the dynamic, action-driven visual task flow customization in accordance with certain embodiments of this disclosure. For example, at reference numeral 702, the device can perform a retry procedure. The retry procedure can reattempt the flow state management procedure following a failure of the flow state management procedure. Typically, the retry procedure can be actionable from a ready state, a failed state, or an exception state.

At reference numeral 704, the device can perform a bypass procedure. The bypass procedure can skip the flow state management procedure, effectively putting the flow state in a completed state. Typically, the bypass state can be actionable from the not ready state, the ready state, and, in some instances from the failed state or the exception state.

At reference numeral 706, the device can perform a dependency management procedure. The dependency management procedure can verify existence of dependencies of the task element. At reference numeral 708, the device can perform a synchronization procedure. The synchronization procedure can verify that data synchronization between first data of the task flow and second data of the operation (e.g., action or automation) of the flow designer module.

### Example Operating Environments

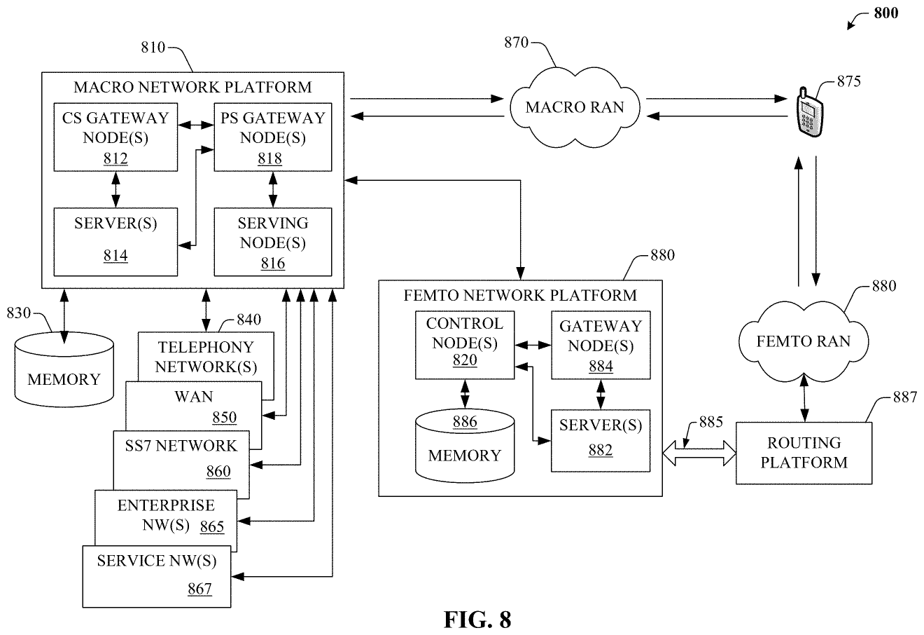

To provide further context for various aspects of the subject specification, FIG. 8 illustrates an example wireless communication environment 800, with associated components that can enable operation of a femtocell enterprise network in accordance with aspects described herein. Wireless communication environment 800 comprises two wireless network platforms: (i) A macro network platform 810 that serves, or facilitates communication with, user equipment 875 via a macro radio access network (RAN) 870. It should be appreciated that in cellular wireless technologies (e.g., 4G, 3GPP UMTS, HSPA, 3GPP LTE, 3GPP UMB, 5G), macro network platform 810 is embodied in a Core Network. (ii) A femto network platform 880, which can provide communication with UE 875 through a femto RAN 890, linked to the femto network platform 880 through a routing platform 887 via backhaul pipe(s) 885. It should be appreciated that femto network platform 880 typically offloads UE 875 from macro network, once UE 875 attaches (e.g., through macro-to-femto handover, or via a scan of channel resources in idle mode) to femto RAN.

It is noted that RAN comprises base station(s), or access point(s), and its associated electronic circuitry and deployment site(s), in addition to a wireless radio link operated in accordance with the base station(s). Accordingly, macro RAN 1370 can comprise various coverage cells, while femto RAN 890 can comprise multiple femto access points or multiple metro cell access points. As mentioned above, it is to be appreciated that deployment density in femto RAN 890 can be substantially higher than in macro RAN 870.

Generally, both macro and femto network platforms 810 and 880 comprise components, e.g., nodes, gateways, interfaces, servers, or platforms, that facilitate both packet-switched (PS) (e.g., internet protocol (IP), Ethernet, frame relay, asynchronous transfer mode (ATM)) and circuit-switched (CS) traffic (e.g., voice and data) and control generation for networked wireless communication. In an aspect of the subject innovation, macro network platform 810 comprises CS gateway node(s) 812 which can interface CS traffic received from legacy networks like telephony network(s) 840 (e.g., public switched telephone network (PSTN), or public land mobile network (PLMN)) or a SS7 network 860. Circuit switched gateway 812 can authorize and authenticate traffic (e.g., voice) arising from such networks. Additionally, CS gateway 812 can access mobility, or roaming, data generated through SS7 network 860; for instance, mobility data stored in a VLR, which can reside in memory 830. Moreover, CS gateway node(s) 812 interfaces CS-based traffic and signaling and gateway node(s) 818. As an example, in a 3GPP UMTS network, gateway node(s) 818 can be embodied in gateway GPRS support node(s) (GGSN).

In addition to receiving and processing CS-switched traffic and signaling, gateway node(s) 818 can authorize and authenticate PS-based data sessions with served (e.g., through macro RAN) wireless devices. Data sessions can comprise traffic exchange with networks external to the macro network platform 810, like wide area network(s) (WANs) 850; it should be appreciated that local area network(s) (LANs) can also be interfaced with macro network platform 810 through gateway node(s) 818. Gateway node(s) 818 generates packet data contexts when a data session is established. To that end, in an aspect, gateway node(s) 818 can comprise a tunnel interface (e.g., tunnel termination gateway (TTG) in 3GPP UMTS network(s); not shown) which can facilitate packetized communication with disparate wireless network(s), such as Wi-Fi networks. It should be further appreciated that the packetized communication can comprise multiple flows that can be generated through server(s) 814. It is to be noted that in 3GPP UMTS network(s), gateway node(s) 818 (e.g., GGSN) and tunnel interface (e.g., TTG) comprise a packet data gateway (PDG).

Macro network platform 810 also comprises serving node(s) 816 that convey the various packetized flows of information or data streams, received through gateway node(s) 818. As an example, in a 3GPP UMTS network, serving node(s) can be embodied in serving GPRS support node(s) (SGSN).

As indicated above, server(s) 814 in macro network platform 810 can execute numerous applications (e.g., location services, online gaming, wireless banking, wireless device management . . . ) that generate multiple disparate packetized data streams or flows, and manage (e.g., schedule, queue, format . . . ) such flows. Such application(s), for example can comprise add-on features to standard services provided by macro network platform 810. Data streams can be conveyed to gateway node(s) 818 for authorization/authentication and initiation of a data session, and to serving node(s) 816 for communication thereafter. Server(s) 814 can also effect security (e.g., implement one or more firewalls) of macro network platform 810 to ensure network's operation and data integrity in addition to authorization and authentication procedures that CS gateway node(s) 812 and gateway node(s) 818 can enact. Moreover, server(s) 814 can provision services from external network(s), e.g., WAN 850, or Global Positioning System (GPS) network(s) (not shown). It is to be noted that server(s) 814 can comprise one or more processor configured to confer at least in part the functionality of macro network platform 810. To that end, the one or more processor can execute code instructions stored in memory 830, for example.

In example wireless environment 800, memory 830 stores information related to operation of macro network platform 810. Information can comprise business data associated with subscribers; market plans and strategies, e.g., promotional campaigns, business partnerships; operational data for mobile devices served through macro network platform; service and privacy policies; end-user service logs for law enforcement; and so forth. Memory 830 can also store information from at least one of telephony network(s) 840, WAN(s) 850, or SS7 network 860, enterprise NW(s) 865, or service NW(s) 867.

Femto gateway node(s) 884 have substantially the same functionality as PS gateway node(s) 818. Additionally, femto gateway node(s) 884 can also comprise substantially all functionality of serving node(s) 816. In an aspect, femto gateway node(s) 884 facilitates handover resolution, e.g., assessment and execution. Further, control node(s) 820 can receive handover requests and relay them to a handover component (not shown) via gateway node(s) 884. According to an aspect, control node(s) 820 can support RNC capabilities.

Server(s) 882 have substantially the same functionality as described in connection with server(s) 814. In an aspect, server(s) 882 can execute multiple application(s) that provide service (e.g., voice and data) to wireless devices served through femto RAN 890. Server(s) 882 can also provide security features to femto network platform. In addition, server(s) 882 can manage (e.g., schedule, queue, format . . . ) substantially all packetized flows (e.g., IP-based) it generates in addition to data received from macro network platform 810. It is to be noted that server(s) 882 can comprise one or more processor configured to confer at least in part the functionality of macro network platform 810. To that end, the one or more processor can execute code instructions stored in memory 886, for example.

Memory 886 can comprise information relevant to operation of the various components of femto network platform 880. For example, operational information that can be stored in memory 886 can comprise, but is not limited to, subscriber information; contracted services; maintenance and service records; femto cell configuration (e.g., devices served through femto RAN 890; access control lists, or white lists); service policies and specifications; privacy policies; add-on features; and so forth.

It is noted that femto network platform 880 and macro network platform 810 can be functionally connected through one or more reference link(s) or reference interface(s). In addition, femto network platform 880 can be functionally coupled directly (not illustrated) to one or more of external network(s) 840, 850, 860, 865 or 867. Reference link(s) or interface(s) can functionally link at least one of gateway node(s) 884 or server(s) 886 to the one or more external networks 840, 850, 860, 865 or 867.

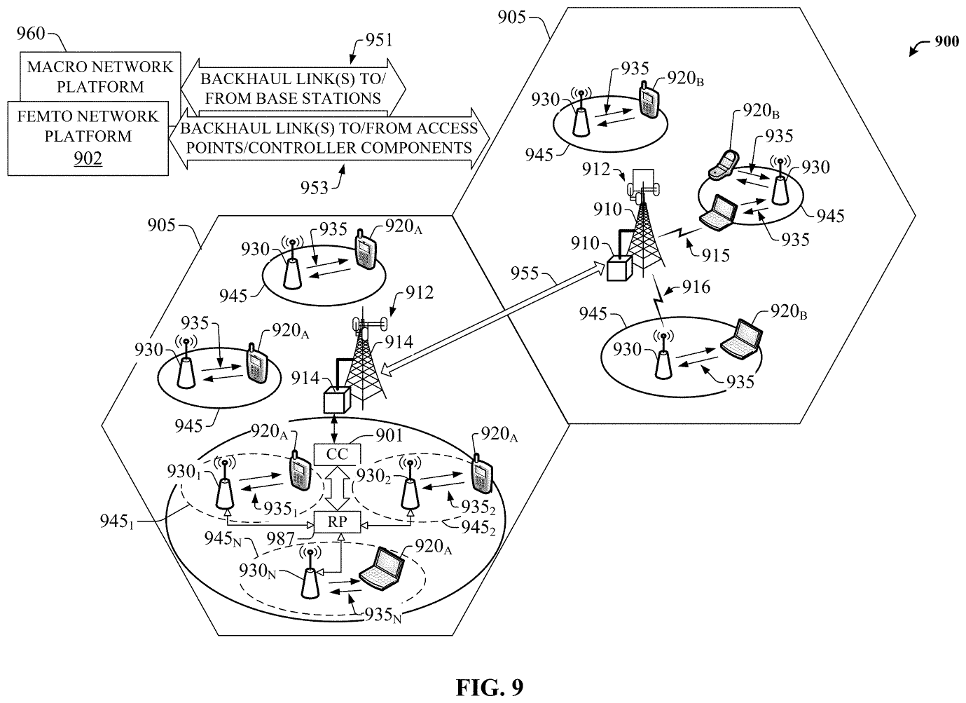

FIG. 9 illustrates a wireless environment that comprises macro cells and femtocells for wireless coverage in accordance with aspects described herein. In wireless environment 905, two areas represent “macro” cell coverage; each macro cell is served by a base station 910. It can be appreciated that macro cell coverage area 905 and base station 910 can comprise functionality, as more fully described herein, for example, with regard to system 900. Macro coverage is generally intended to serve mobile wireless devices, like UE 920_{A}, 920_{B}, in outdoors locations. An over-the-air (OTA) wireless link 935 provides such coverage, the wireless link 935 comprises a downlink (DL) and an uplink (UL), and utilizes a predetermined band, licensed or unlicensed, of the radio frequency (RF) spectrum. As an example, UE 920_{A}, 920_{B} can be a 3GPP Universal Mobile Telecommunication System (UMTS) mobile phone. It is noted that a set of base stations, its associated electronics, circuitry or components, base stations control component(s), and wireless links operated in accordance to respective base stations in the set of base stations form a radio access network (RAN). In addition, base station 910 communicates via backhaul link(s) 951 with a macro network platform 960, which in cellular wireless technologies (e.g., 3rd Generation Partnership Project (3GPP) Universal Mobile Telecommunication System (UMTS), Global System for Mobile Communication (GSM)) represents a core network.

In an aspect, macro network platform 960 controls a set of base stations 910 that serve either respective cells or a number of sectors within such cells. Base station 910 comprises radio equipment 914 for operation in one or more radio technologies, and a set of antennas 912 (e.g., smart antennas, microwave antennas, satellite dish(es) . . . ) that can serve one or more sectors within a macro cell 905. It is noted that a set of radio network control node(s), which can be a part of macro network platform 960; a set of base stations (e.g., Node B 910) that serve a set of macro cells 905; electronics, circuitry or components associated with the base stations in the set of base stations; a set of respective OTA wireless links (e.g., links 915 or 916) operated in accordance to a radio technology through the base stations; and backhaul link(s) 955 and 951 form a macro radio access network (RAN). Macro network platform 960 also communicates with other base stations (not shown) that serve other cells (not shown). Backhaul link(s) 951 or 953 can comprise a wired backbone link (e.g., optical fiber backbone, twisted-pair line, T1/E1 phone line, a digital subscriber line (DSL) either synchronous or asynchronous, an asymmetric ADSL, or a coaxial cable . . . ) or a wireless (e.g., LoS or non-LoS) backbone link. Backhaul pipe(s) 955 link disparate base stations 910. According to an aspect, backhaul link 953 can connect multiple femto access points 930 and/or controller components (CC) 901 to the femto network platform 902. In one example, multiple femto APs can be connected to a routing platform (RP) 987, which in turn can be connect to a controller component (CC) 901. Typically, the information from UEs 920_{A} can be routed by the RP 987, for example, internally, to another UE 920_{A} connected to a disparate femto AP connected to the RP 987, or, externally, to the femto network platform 902 via the CC 901, as discussed in detail supra.

In wireless environment 905, within one or more macro cell(s) 905, a set of femtocells 945 served by respective femto access points (APs) 930 can be deployed. It can be appreciated that, aspects of the subject innovation can be geared to femtocell deployments with substantive femto AP density, e.g., 9⁴-10⁷ femto APs 930 per base station 910. According to an aspect, a set of femto access points 930₁-930_{N}, with N a natural number, can be functionally connected to a routing platform 987, which can be functionally coupled to a controller component 901. The controller component 901 can be operationally linked to the femto network platform 902 by employing backhaul link(s) 953. Accordingly, UE 920_{A} connected to femto APs 930₁-930_{N} can communicate internally within the femto enterprise via the routing platform (RP) 987 and/or can also communicate with the femto network platform 902 via the RP 987, controller component 901 and the backhaul link(s) 953. It can be appreciated that although only one femto enterprise is depicted in FIG. 9, multiple femto enterprise networks can be deployed within a macro cell 905.

It is noted that while various aspects, features, or advantages described herein have been illustrated through femto access point(s) and associated femto coverage, such aspects and features also can be exploited for home access point(s) (HAPs) that provide wireless coverage through substantially any, or any, disparate telecommunication technologies, such as for example Wi-Fi (wireless fidelity) or picocell telecommunication. Additionally, aspects, features, or advantages of the subject innovation can be exploited in substantially any wireless telecommunication, or radio, technology; for example, Wi-Fi, Worldwide Interoperability for Microwave Access (WiMAX), Enhanced General Packet Radio Service (Enhanced GPRS), 3GPP LTE, 3GPP2 UMB, 3GPP UMTS, HSPA, HSDPA, HSUPA, or LTE Advanced. Moreover, substantially all aspects of the subject innovation can comprise legacy telecommunication technologies.

With respect to FIG. 9, in example embodiment 900, base station AP 910 can receive and transmit signal(s) (e.g., traffic and control signals) from and to wireless devices, access terminals, wireless ports and routers, etc., through a set of antennas 912₁-912_{N}. It should be appreciated that while antennas 912₁-912_{N} are a part of communication platform 925, which comprises electronic components and associated circuitry that provides for processing and manipulating of received signal(s) (e.g., a packet flow) and signal(s) (e.g., a broadcast control channel) to be transmitted. In an aspect, communication platform 925 comprises a transmitter/receiver (e.g., a transceiver) 966 that can convert signal(s) from analog format to digital format upon reception, and from digital format to analog format upon transmission. In addition, receiver/transmitter 966 can divide a single data stream into multiple, parallel data streams, or perform the reciprocal operation. Coupled to transceiver 966 is a multiplexer/demultiplexer 967 that facilitates manipulation of signal in time and frequency space. Electronic component 967 can multiplex information (data/traffic and control/signaling) according to various multiplexing schemes such as time division multiplexing (TDM), frequency division multiplexing (FDM), orthogonal frequency division multiplexing (OFDM), code division multiplexing (CDM), space division multiplexing (SDM). In addition, mux/demux component 967 can scramble and spread information (e.g., codes) according to substantially any code known in the art; e.g., Hadamard-Walsh codes, Baker codes, Kasami codes, polyphase codes, and so on. A modulator/demodulator 968 is also a part of operational group 925, and can modulate information according to multiple modulation techniques, such as frequency modulation, amplitude modulation (e.g., M-ary quadrature amplitude modulation (QAM), with M a positive integer), phase-shift keying (PSK), and the like.

Referring now to FIG. 10, there is illustrated a block diagram of an exemplary computer system operable to execute the disclosed architecture. In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This comprises at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic “10BaseT” wired Ethernet networks used in many offices.

What has been described above comprises examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

As used in this application, the terms “system,” “component,” “interface,” and the like are generally intended to refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. These components also can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry that is operated by software or firmware application(s) executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. An interface can comprise input/output (I/O) components as well as associated processor, application, and/or API components.

Furthermore, the disclosed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from by a computing device.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory. In addition, memory components or memory elements can be removable or stationary. Moreover, memory can be internal or external to a device or component, or removable or stationary. Memory can comprise various types of media that are readable by a computer, such as hard-disc drives, zip drives, magnetic cassettes, flash memory cards or other types of memory cards, cartridges, or the like.

By way of illustration, and not limitation, nonvolatile memory can comprise read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments comprise a system as well as a computer-readable medium having computer-executable instructions for performing the acts and/or events of the various methods.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communications media comprise wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

What is claimed is:

1. A device, comprising:
a processor; and
a memory that stores executable instructions that, when executed by the processor, facilitate performance of operations, the operations comprising:
presenting, within a development environment of a software-as-a-service platform, a task element, expressing a task workflow, that is modeled as a record of an order data model of the development environment;
executing the task workflow according to a flow state management procedure and, in response to the executing, updating the record according to a current state of the task element; and
correlating the task element to an operation of a flow designer module of the development environment.

2. The device of claim 1, wherein the order data model of the development environment is a framework that enables network equipment associated with telecommunication network service providers to manage, orchestrate, and fulfill customer orders for different types of products and services.

3. The device of claim 1, wherein the flow designer module of the development environment is part of a framework configured to enable approvals, tasks, notifications, and record operations in the development environment.

4. The device of claim 1, wherein the operation of the flow designer module comprises one of a group comprising: a flow operation, a subflow operation, and an action operation.

5. The device of claim 1, wherein the software-as-a-service platform is enabled by cloud equipment associated with a cloud software-as-a-service provider.

6. The device of claim 1, wherein the task element is presented in a visual task board generated by the flow designer module of the development environment.

7. The device of claim 1, wherein the operations further comprise: executing a retry procedure that reattempts the flow state management procedure following a failure of the flow state management procedure.

8. The device of claim 1, wherein the operations further comprise: executing a bypass procedure that foregoes the flow state management procedure.

9. The device of claim 1, wherein the operations further comprise: executing a dependency management procedure that verifies existence of dependencies of the task element.

10. The device of claim 1, wherein the operations further comprise: executing a synchronization procedure that verifies data synchronization between first data of the task flow and second data of the operation of the flow designer module.

11. A non-transitory machine-readable medium, comprising executable instructions that, when executed by a processor, facilitate performance of operations, comprising:
within a development environment of a software-as-a-service platform, presenting, on a visual task board of the development environment, a task element, expressing a task workflow, wherein the task element is modeled as a record in an order data model of the development environment;
in response to a flow state management procedure that executes the task workflow, determining a current state of that task element;
updating the record according to the current state determined by the flow state management procedure; and
correlating the task element to an operation of a flow designer module of the development environment.

12. The non-transitory machine-readable medium of claim 11, wherein the order data model of the development environment is a framework that provides network equipment associated with telecommunication network service providers configured to manage, orchestrate, and fulfill customer orders for different types of products and services.

13. The non-transitory machine-readable medium of claim 11, wherein the flow designer module of the development environment is a framework that automates approvals, tasks, notifications, and record operations.

14. The non-transitory machine-readable medium of claim 11, wherein the operation of the flow designer module comprises one of a group comprising: a flow operation, a subflow operation, and an action operation.

15. The non-transitory machine-readable medium of claim 11, wherein the task element is presented in a visual task board generated by the flow designer module of the development environment.

16. A method, comprising:
within a development environment of a software-as-a-service platform, presenting, by a device comprising a processor, a task element, expressing a task workflow, that is modeled as a record of an order data model of the development environment;
executing, by the device, the task workflow in a flow state management procedure and, in response, updating the record according to a current state of that task element; and
constructing, by the device, a relationship between the task element and an operation of a flow designer module of the development environment.

17. The method of claim 16, further comprising performing, by the device, a retry procedure that reattempts the flow state management procedure following a failure of the flow state management procedure.

18. The method of claim 16, further comprising performing, by the device, a bypass procedure that skips the flow state management procedure.

19. The method of claim 16, further comprising performing, by the device, a dependency management procedure that verifies existence of dependencies of the task element.

20. The method of claim 16, further comprising, performing, by the device, a synchronization procedure that verifies data synchronization between first data of the task flow and second data of the operation of the flow designer module.
